(19) United States
(12) Patent Application Publication
(10) Pub. No.: US 2017/0166394 A1
(43) Pub. Date: Jun. 15, 2017

(54) FIRE RESISTANT CONTAINER

(71) Applicant: GOODWIN PLC, Stoke-on-Trent (GB)

(72) Inventor: Andrew BAYLAY, Stoke-on-Trent (GB)

(21) Appl. No.: 15/328,003

(22) PCT Filed: Jul. 17, 2015
(86) PCT No.: PCT/GB2015/052082

§ 371 Date: Jan. 20, 2017

(30) Foreign Application Priority Data
Jul. 21, 2014 (GB) 1412902.7
Mar. 10, 2015 (GB) 1504039.7

(51) Int. Cl. B65D 90/22; C03C 17/25; B65D 88/74; B65D 88/16; B65D 90/02

(52) U.S. Cl. CPC B65D 90/22; B65D 88/1681; B65D 90/022; B65D 88/74; C03C 17/25; C03C 2218/111

(57) ABSTRACT

A flexible fire-resistant container comprising a woven material coated or impregnated with a fire-resistant coating, especially where the fire-resistant coating comprises vermiculite, and optionally where the woven material is made from fibreglass or fibres thereof, silica glass or fibres thereof, or ceramic glass or fibres thereof; and methods for the production of such a container.

The invention relates to the manufacture of fire-resistant flexible containers. In particular, the invention relates to the use of a coating or impregnation composition comprising vermiculite in the production of flexible containers, to fire-resistant flexible containers comprising one or more flexible materials coated or impregnated with vermiculite, and to methods of their production.

Global trade and industry requires the storage and transportation of many billions of tonnes of material. Various standard and custom size containers are used to hold material, such as intermodal shipping containers, intermediate bulk containers (IBCs), and flexible intermediate bulk containers (FIBCs). FIBCs have proved to be especially useful in the storage and transportation of products, particularly dry products, including powdered chemicals, construction materials such as sand and cement, animal feedstocks, and material for recycling such as plastics.

Much of the material that is transported and stored for use in trade and industry is flammable, including paper, wood, plastics, chemicals and the like. There is therefore a need for containers which are both suitable for transportation and storage of materials and which are resistant to fire. For example, there is a need for containers which are both suitable for transportation and storage of bulk materials and which are resistant to fire. There is also a need for smaller flexible fire-resistant containers.

Typically, FIBCs are constructed from woven materials, especially polyethylene or polypropylene. Both polyethylene and polypropylene have relatively low ignition temperatures of around 360° C. to 380° C. With many products burning at temperatures significantly higher than these ignition temperatures, FIBCs made from polyethylene and polypropylene offer little fire protection.

Lithium ion batteries are commonly used for powering electrical equipment. Recently two major airlines have announced that they will no longer carry bulk shipments of lithium-ion batteries because of concerns that a faulty battery overheating could lead to a major fire. A flexible container such as an FIBC which was capable of containing a fire within the flexible container could allow safe carriage of bulk shipments of lithium-ion batteries.

The invention relates to fire-resistant containers, particularly FIBCs, and methods for their production. In one embodiment of the invention, fire resistance is obtained by coating the flexible material from which the container is constructed with a non-flammable coating composition. In alternative embodiments, the non-flammable coating composition is impregnated into the flexible material. In a preferred embodiment of the invention, the non-flammable coating composition comprises expanded vermiculite.

Vermiculite is a naturally occurring hydrous silicate mineral of chemical formula (Mg,Fe,Al)₃(Al,Si)₄O₁₀(OH)_{2.}4H₂O. Vermiculite has a hydrated laminar structure and when heated (typically to temperatures from 700° C. to 1000° C.) or chemically treated it expands in a process known as exfoliation. In the exfoliation process the dense flakes of ore are converted into lightweight porous granules containing minute air layers. The terms ‘expanded vermiculite’ and ‘exfoliated vermiculite’ can be used interchangeably. Exfoliated vermiculite granules are non-combustible and can therefore act as fire-resistants.

Exfoliated vermiculite granules are insoluble in water and in all organic solvents. However, once exfoliated they can be suspended in a stable aqueous dispersion, using methods such as those described in U.S. Pat. No. 6,309,740.

A flexible woven material can be coated with or impregnated by an expanded vermiculite coating from a dispersion of fine exfoliated vermiculite particles. The woven material can be coated or impregnated with expanded vermiculite, for example by a dip process or alternatively by spraying or otherwise applying a dispersion of exfoliated vermiculite. Such a material can be particularly useful for production of the containers as described herein.

Generally it is preferred that the exfoliated vermiculite comprises chemically exfoliated vermiculite. However the exfoliated vermiculite may alternatively or additionally comprise thermally exfoliated vermiculite. It is preferred that the exfoliated vermiculite should comprise between 90% and 100% chemically exfoliated vermiculite with between 10% and 0% thermally exfoliated vermiculite.

One object of the invention is therefore to provide a fire-resistant container such as a fire-resistant FIBC, wherein fire resistance can be achieved by coating or impregnating the material used to produce the container with a fire-resistant coating comprising expanded vermiculite. A further object of the invention is to provide a method for producing such a fire-resistant container.

Another object of the invention is to provide a fire-resistant container such as an FIBC meeting the requirements of UN Hazardous Goods Packaging Group II standards, compliant with Euro Class A (non-combustible) and preferably fire-resistant to a maximum temperature (continuous) rating of 600, 1000 or 1200 degree centigrade or higher, such as 1500° C.

The invention will be further understood by means of the following description and figures given by example only in which:

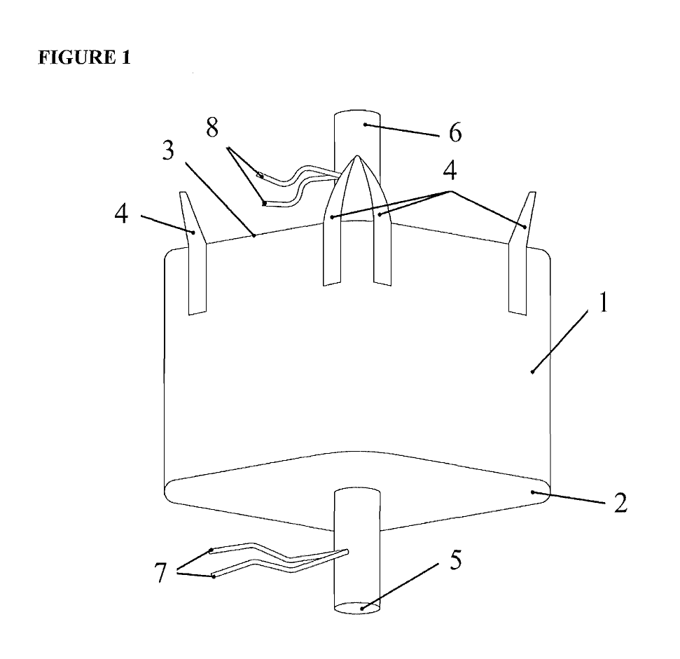

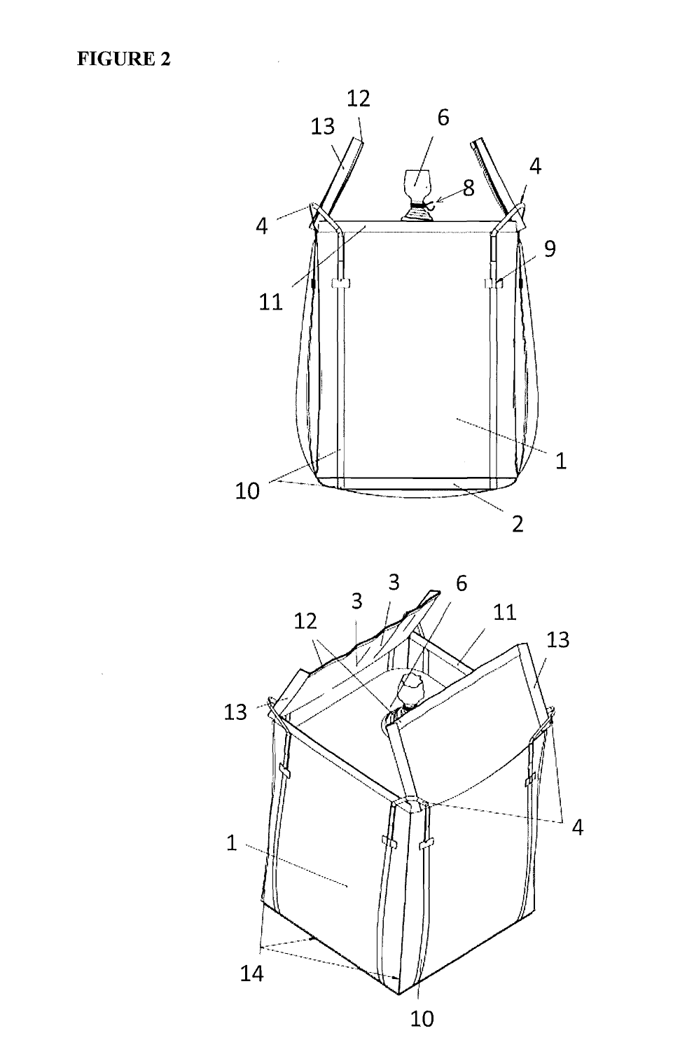

FIGS. 1 and 2 are schematics of a fire-resistant FIBC.

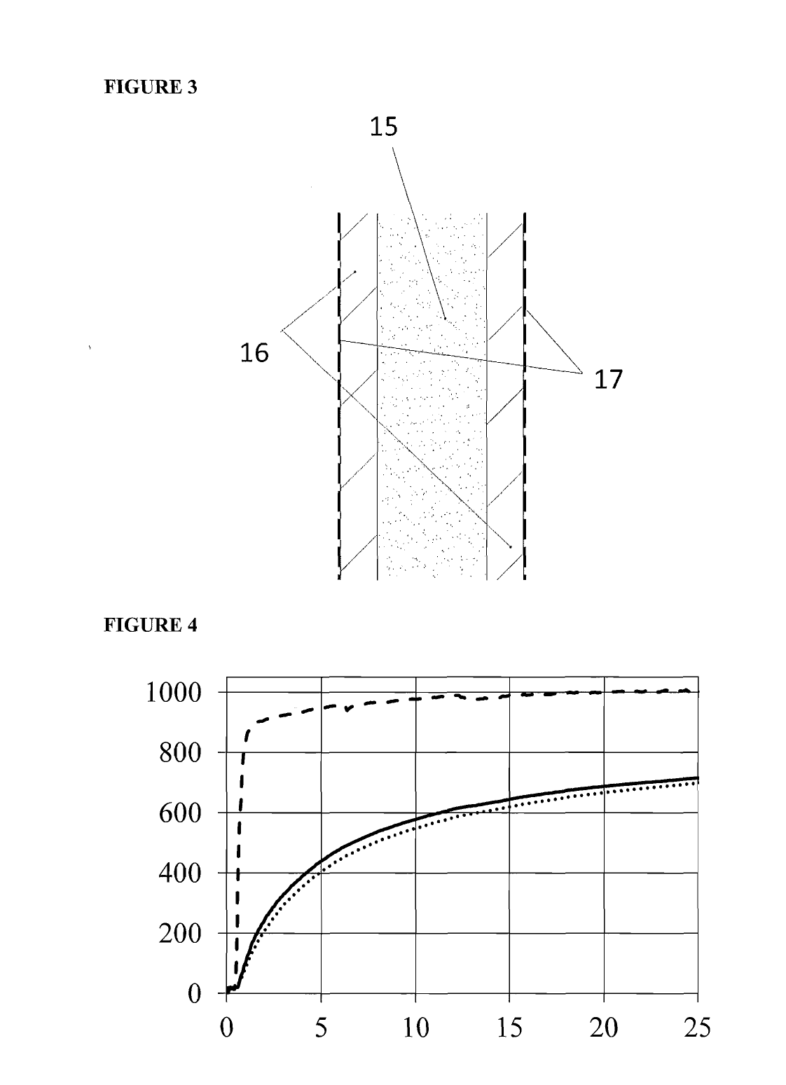

FIG. 3 is a cross section through a flexible fire-resistant material for the manufacture of a fire-resistant container such as a fire-resistant FIBC.

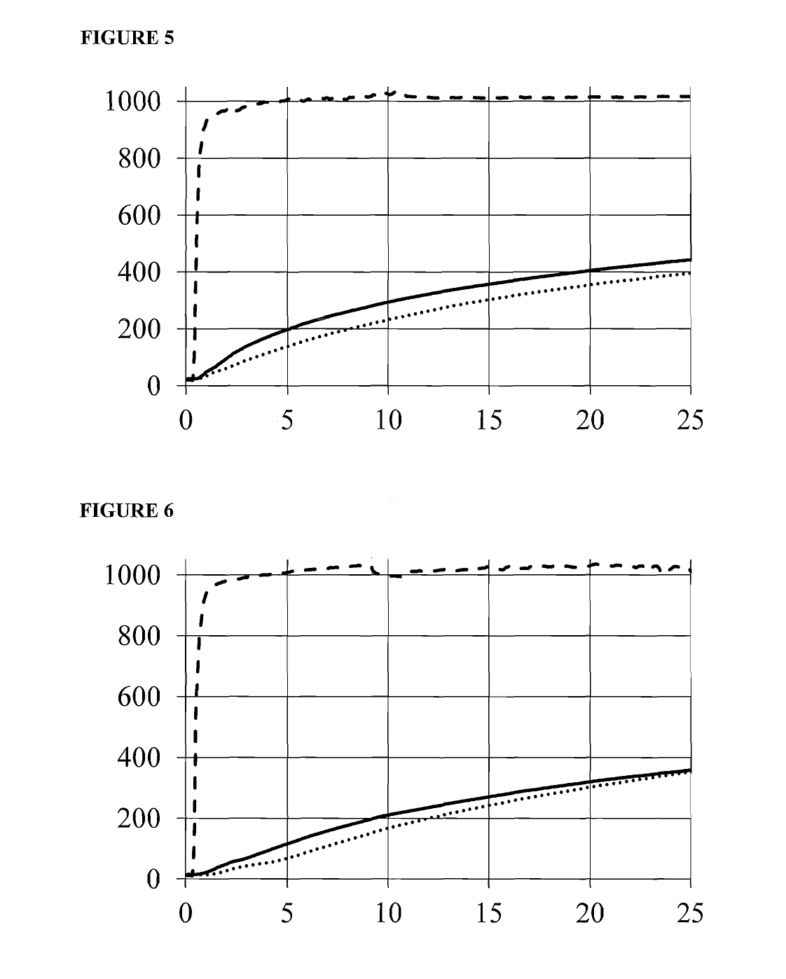

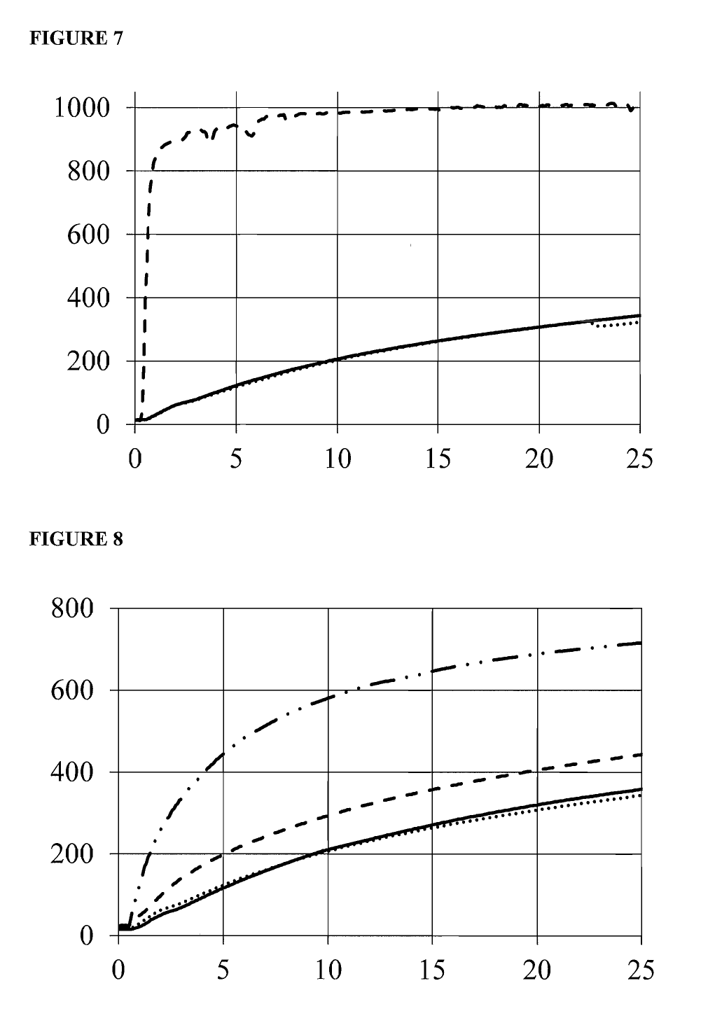

FIGS. 4 to 7 show temperatures experienced at hot and cold faces of materials used for producing fire-resistant containers as described in Example 4. The data indicate the temperature at the relevant face of the fabric following heating to 1000° C. as described in Example 4. The x axis is the time in minutes and they axis is the temperature in ° C. FIG. 4 (single fabric, no insulation); FIG. 5: 6 mm insulation); FIG. 6 (10 mm insulation); FIG. 7 (12 mm insulation). Results for the cold face of the fabrics are collated in FIG. 8.
Legend: - - - (hot face);—(cold face); . . . . . (cold face; 1 mm spacing)

FIG. 8 shows comparative results obtained in fabric testing of materials suitable for producing fire-resistant containers. The data indicate the temperature at the cold face of the fabric following heating to 1000° C. as described in Example 4. The x axis is the time in minutes and they axis is the temperature in ° C.
Legend: [symbol] (single fabric); - - - - (6 mm insulated fabric);—(10 mm insulated fabric); . . . . (12 mm insulated fabric)

Flexible Intermediate Bulk Containers (FIBCs), also known as ‘bulk bags’ or ‘big bags’ are containers commonly used for the transportation and storage of bulk industrial materials, especially those in powder, flake or granular form. FIBCs can hold loads ranging in mass from about 100 kg or less to 2000 kg or more, preferentially from 500 kg to 2000 kg, for example 1000 kg. Fire-resistant containers of other sizes are also encompassed by the invention as described herein. For example, smaller containers are often useful for holding lower masses such as from about 1 kg or less to 100 kg or more such as about 1 kg or less to 30 kg or more.

The fire-resistant container can be manufactured to have an appropriate volume for the mass of product to be contained within. In some embodiments the volume of the container can be from 0.0005 m³ or greater to 3 m³ or more. For example, the volume of the container can sometimes range from about 0.001 m³ to about 2 m³. When a smaller load is required, the volume of the fire-resistant container can be appropriately scaled, and may be e.g. from 0.0005 m³ to 0.5 m³ such as from 0.001 to 0.1 m³, preferentially from 0.001 to 0.05 m³ and more preferentially from 0.002 to 0.005 m³. In other cases, a larger size may be useful, such as from 0.1 m³ or less to 3 m³ or more, preferentially from 0.2 m³ to 2.5 m³, still more preferably from 0.5 m³ to 2 m³, such as from 0.8 m³ to 1.5 m³, for example 1 m³. A typical container may, for example, have dimensions of from about 0.10×0.10×0.10 m to about 1.5×1.5×1.5 m, such as from about 0.15×0.15×0.15 m to about 1.2×1.2×1.2 m.

FIG. 1 is a schematic of a fire-resistant FIBC comprising one or more side panels 1 which may be formed by one or more pieces of material joined or seamed together; one or more base panels 2 which may be integral with one or more of the side panels 1 or may be joined or seamed to the side panels 1 and which may optionally comprise an opening or discharge point 5; one or more optional lid panels 3 which may be integral with one or more of the side panels 1 or may be joined or seamed to one or more of the side panels 1 and which may comprise an opening or access point 6; one or more optional points, straps, handles or fastenings 4 from which the FIBC can be lifted. FIG. 1 shows one example of a discharge point 5 and access point 6 in the form of a discharge spout 5 and a filling spout 6 that can be closed by tying with closing ties 7, 8.

FIG. 2 is two views of a schematic of a fire-resistant FIBC comprising features as described for FIG. 1 and further comprising optional reinforcement 9 around optional lifting straps 4; optional reinforced webbing from lifting straps 4 which continue underneath FIBC; optional connection 11 to 13 which seals the optional lid panel 3 to the side panel of the FIBC 1; and optional reinforcement stitching 14.

FIG. 3 is a schematic of a layered sandwich material as described herein which may be used to construct a fire-resistant container such as an FIBC. The sandwich material comprises one or more layers of an insulating material 15 enclosed in fire-resistant material 16 which may typically be coated or impregnated with a fire-resistant compound such as expanded vermiculite and optionally further coated by one or more additional coatings 17 as described herein.

Certain features applicable to fire-resistant containers are now described by way of example only with reference to Flexible Intermediate Bulk Containers. It should be understood that these features are applicable to flexible containers which are not typically considered as FIBCs because of their size, FIBCs typically being containers of base size 50 cm by 50 cm to 120 cm by 120 cm and height 50 cm to 200 cm. Flexible fire-resistant containers as described herein may be of smaller size appropriate for their intended application but may use one or more of the features described by reference to FIBCs.

FIBCs can be produced in a number of physical forms. In some embodiments the FIBC can be cubic or cuboid in shape (‘box shaped’), whilst in other embodiments the FIBC can be cylindrical (‘drum shaped’). In other embodiments FIBCs can be constructed such that each side is a separate piece of material (‘4 panel’ construction), or a ‘U-panel’ construction can be used in which seams along two opposite sides are used. In some embodiments the FIBC can be made using circular or tubing construction methods which can be advantageous in order to minimise seams, which is particularly useful when the contents are fine or hygroscopic. In some embodiments the FIBC can comprise baffles, which can help to prevent bulging and thus keep the filled FIBC in a desired shape, for example cuboid. In some embodiments the FIBC may comprise additional straps, webbing, reinforcement or other strengthening means. Typically these may be integral to and/or used in conjunction with lifting means if provided to allow the FIBC to be transported more safely when full.

FIBCs can be provided with one or more opening or access points to enable contents to be added. Therefore, an FIBC can be equipped with an open top with or without a hem, or an access slot or slit may be provided. In some embodiments, a filling spout can be incorporated into a fixed or removable cover of the container. Still other access points include a domed or conical top which may also comprise an access spout; a ‘duffel top’; and a cover which is either wholly or partially removable and which may be fastened to the FIBC by means of a suitable fixing. Suitable fixings include zips, hook-and-loop connectors, eyelets, toggles, and ties. Tightening holes or draw cords may be included in the cover of the FIBC. In other embodiments, a cover may fit over the top of an FIBC without an additional fastener. For storage of volatile, flammable, explosive, hygroscopic or dangerous contents, it is advantageous for the FIBC to have a lid or cover that acts as a barrier between the contents and the outside of the container.

In some embodiments, it is advantageous for an FIBC to be equipped with a skirt or cover comprising a filling point. For example, an FIBC may comprise a removable skirt which comprises a filling spout or access point which may typically be positioned across the top of the FIBC. The skirt may typically be positioned in a position to accommodate ullage and/or specified or anticipated movement of the product such as settling or expansion for example in transport or storage. The skirt may be made of the same or different material to the body of the FIBC. Preferably, the skirt may be of material of appropriate flexibility to be manipulated (eg twisted closed) by hand. A spout may be fastened with an appropriate cord, for example comprising a material such as Kevlar, for example of diameter 1 to 10 mm such as from 2 to 5 mm e.g. about 3 mm.

In some embodiments it is advantageous for an FIBC to be equipped with more than one cover. For example, an FIBC may comprise a skirt comprising an access and/or filling spout, and may further comprise one or more further coverings. The further coverings may be fixed or removable. The further coverings may for example comprise one flap covering a face or substantially all of a face of the FIBC. Alternatively the further covering may comprise two or more, such as two to four, typically two flaps (also known as leaves) which may join or connect together to comprise the covering. Any suitable joining or connecting means may be used, for example zips, press-studs, hook-and-loop connectors (such as Velcro), eyelets, toggles, ties, tightening holes and draw cords or stitching may be used. Typically, a hook and loop connector such as Velcro is used.

FIBCs are also typically provided with a discharge point, although it is possible instead to simply cut open the FIBC to release the contents or the contents may be lifted from the container after opening the lid if present. Discharge points can include discharge spouts, which may further comprise protective elements such iris protection, a sewn cover, or a protective flap. The spout may be closed with a draw string, a tie, or may have a cover. In some embodiments, the FIBC may have an opening to allow the contents to be released. In some embodiments this opening may be the whole side or base of the FIBC, or the opening may only form part of the base or side. Other methods of releasing the discharge point include zips, hook-and-loop connectors, eyelets, toggles, ties, tightening holes and draw cords. In some embodiments the discharge point may be covered by one or more additional coverings which may be removable or fixed to the FIBC. For example, the one or more additional coverings may comprise one flap or may comprise two or more, such as two to four, typically two flaps or leaves which may join or connect together to comprise the covering. Any suitable joining or connecting means may be used, for example zips, press-studs, hook-and-loop connectors (such as Velcro), eyelets, toggles, ties, tightening holes and draw cords or stitching may be used. Typically, a hook and loop connector such as Velcro is used. However, for some applications, for example where especially high fire-resistance is required, it is preferable to use the filling opening/access point to both fill and empty the container in which case a discharge point may be omitted.

FIBCs can comprise various points, straps, handles or fastenings to allow them to be lifted by machinery such as forklift trucks and cranes. For example, cross-corner loops or side-seam loops can be included. Sleeve-lift or hood-lift mechanisms can be used. One or more Stevedore straps can be incorporated.

Typically FIBCs are manufactured from polypropylene (PP) or polyethylene (PE). Alternatively FIBCs can be made from HDPE, jute, hessian, or other flexible materials. Typically, the material used to construct FIBCs is woven for greater strength and flexibility of the resultant container.

For the storage of certain materials, it is advantageous for the container to be electrostatically resistant. In this regard, FIBCs are currently often classified as Type A to Type D. Type A FIBCs incorporate no electrostatic safety features, and are typically used to transport non-flammable products. Their use should be avoided when flammable solvents or gases are present in the vicinity of the container. Type B FIBCs are not capable of propagating brush discharges, and therefore are sometimes used to transport flammable materials. However, whilst they offer a low level of protection against electrostatic discharge, they are not fire-resistant and therefore offer no protection against an external ignition source. They also cannot contain fires and therefore do not prevent flame propagation between FIBCs containing flammable material. Type C FIBCs are produced from materials which comprise interconnected conductive pathways which can be grounded. They therefore offer enhanced protection against the build-up and discharge of electrostatic charge. However, like Type B FIBCs, Type C FIBCs are not fire-resistant; they therefore offer no protection against external ignition sources and cannot prevent flame propagation between FIBCs containing flammable material. Type D FIBCs are manufactured from materials designed to dissipate electrostatic charge without requiring grounding. In one manifestation, quasi-conductive yarn is incorporated into the material to be used in the construction of the FIBC, which permits dissipation of electrostatic charge through coronal discharge. However, like Type B and Type C FIBCs, Type D FIBCs are not fire-resistant, offer no protection against external ignition sources and cannot prevent flame propagation.

For the storage of flammable materials, therefore, the development of a fire-resistant container is highly desirable. For example, for the storage of bulk materials, the development of a fire-resistant FIBC is highly desirable. Such a fire-resistant container would not only offer protection against external ignition sources but would also prevent flame propagation between containers containing flammable material. In certain embodiments of the present invention, the fire-resistant container comprises one or more features from those known in Type B, Type C and Type D FIBCs in order to mitigate against electrostatic discharge.

A fire-resistant container is a container capable of resisting or retarding fire and thus providing fire protection to the contents of the container. A fire-resistant FIBC is an FIBC capable of resisting or retarding fire and thus providing fire protection to the contents of the FIBC. Usually, a fire-resistant container is capable of resisting ignition, and not only retarding spread of fire or flame. A fire-resistant container has certain properties which pertain both to fire and to radiated heat from other sources. These properties provide for resilience against naked flame and/or indirect heat sources, such as radiated heat from an industrial process or any other high temperature heat source. In a preferred embodiment of the invention, the container allows for zero ignition, zero spread of fire and a maximum temperature (continuous) rating of 600, 1000 or 1200 degree centigrade or higher, such as 1500° C. A fire-resistant container can thus be used to protect the contents of the container from an external fire or heat source and/or to prevent fire occurring within the container from spreading outside the container.

Coating a flexible woven material suitable in strength for use in the manufacture of a fire-resistant container such as a fire-resistant FIBC with dispersed vermiculite applied to the material from a suspension of expanded vermiculite will provide increased fire resistance compared with the untreated material. Advantageous improvements in fire resistance may therefore be obtained in this manner from conventional materials for the production of FIBCs such as polyethylene or polypropylene. However preferred flexible woven materials for the purposes of the present invention are materials which have higher levels of fire resistance before coating. Examples of most suitable flexible woven material for coating with expanded vermiculite for the manufacture of fire-resistant containers include fibreglass, glassfibre and E-Glass, silica glass or fibres thereof, and ceramic glass or fibres thereof

A typical material used in the production of a fire-resistant container such as an FIBC may comprise a woven material of surface density from 100 to 1500 g/m², such as from 200 to 1000 g/m², more typically from 300 to 600 g/m². Different parts of the container may be made from different materials. For example, when the container comprises a skirt comprising an access spout and also comprises a further covering, the skirt may comprise a material with a surface density from 100 to 500 g/m², such as from 200 to 400 g/m² e.g. about 300 g/m², and the additional covering may comprise a material with a surface density from 400 to 1500 g/m², such as from 500 to 1200 g/m² e.g. from 600 to 1000 g/m² such as about 600 g/m².

A typical material for use in the construction of the container may have a tensile strength as follows:

Warp: typically from 1000 to 8000 N/5 cm, more typically from 2000 to 5000 N/5 cm, still more typically from 3000 to 4000 N/5 cm such as about 3500 N/5 cm; and/or
Weft: typically from 500 to 6000 N/5 cm, more typically from 1000 to 4000 N/5 cm, still more typically from 2000 to 3000 N/5 cm such as about 2500 N/5 cm.

In a preferred embodiment, the coating composition is applied to a substrate from a suspension of expanded vermiculite. Preferentially the suspension is an aqueous suspension and in particular a suspension of expanded vermiculite in water although in alternative embodiments the suspension can be formed using an organic solvent or a mixed solvent system. The expanded vermiculite is included in the suspension in amounts from 3% to 40% by weight with respect to the total weight of the suspension, preferably from 10% to 35% by weight, more preferably from 15% to 30% by weight, for example 20% or 25% by weight.

The expanded vermiculite in the suspension is preferably very fine with particle size as measured by laser diffraction between 1 nm and 1000 μm, preferably not greater than 300 μm. The D90 particle size dispersion (wherein 90% of particles are less than the given size) is preferably in the range 100 μm to 300 μm, more preferably 140 μm to 250 μm, and still more preferably 160 μm to 200 μm. The coating composition may be free of additives, or may contain one or more additional components. Preferred additives include kaolin, Bentonite or other such clay derivatives, chelating agents, and organic or inorganic binders.

Generally it is preferred that the suspension is a suspension of exfoliated vermiculite where the exfoliated vermiculite comprises chemically exfoliated vermiculite. The exfoliated vermiculite may alternatively or additionally comprise thermally exfoliated vermiculite. It is preferred that the exfoliated vermiculite should comprise between 90% and 100% chemically exfoliated vermiculite with between 10% and 0% thermally exfoliated vermiculite.

In one embodiment, the material to be coated or impregnated with a coating composition comprising expanded vermiculite is coated by dip coating. In this technique the material is fed under tension into a coating machine comprising a bath containing the coating composition. The material is fully submerged in the bath in order to ensure total coverage by the coating composition. Excess coating composition can be removed by passing the material through rollers, before the material is heated to dry the coating composition onto the surface of the material. In alternative embodiments, the coating composition can be applied by spraying, rolling, or by application with a brush. The vermiculite coating on the fabric may typically be a very thin coating; for example, from 5 to 100 g/m², more typically from 10 to 50 g/m², still more typically from 15 to 35 g/m² such as from 20 to 30 g/m² e.g. about 25 g/m². The intention is to impart fire-resistant properties while maintaining flexibility of the coated material.

A fire-proof container such as an FIBC can be manufactured from a material which has been previously treated with a fire-resistant coating composition. In one embodiment the material is a woven fabric which may be made from ceramic fibres, silica fibres or glass fibres such as E-glass fibres. The coating composition can comprise expanded vermiculite. In other embodiments of the invention, a fire-resistant container such as an FIBC can be wholly or partially assembled from a wholly or partially uncoated material, which may be a woven fabric, which may be made from ceramic fibres, silica fibres or glass fibres such as E-glass fibres. Following the complete or partial production of the container, a fire-resistant coating which may comprise expanded vermiculite can be applied to generate a fire-proof container. For example, a container as described herein may comprise a material comprising from 94 to 96 wt % SiO2 and from 3 to 4 wt % Al₂O₃.

Where the container is assembled by attaching individual woven fabric sections together the attachment method is preferably one which provides integrity for the completed container even when subjected to fire or elevated temperature. A preferred attachment method is by sewing with a thread which will retain integrity when the container is exposed to fire or elevated temperature. In a preferred embodiment the attachment is by means of a metallic thread that can withstand extremely high temperatures, for example a metallic thread that can withstand elevated temperatures of in excess of 900° C., preferably in excess of 1000° C. or more than 1100° C. or 1200° C., such as 1500° C. An example of a suitable high temperature metallic thread with good mechanical strength is Helios Kevlar sewing thread available from Padtex Insulation which comprises a special steel core and a Kevlar cover. The steel core can withstand prolonged temperatures of approximately 1100° C. and is very strong due to the combined effect of the steel core and Kevlar cover. The Kevlar cover ensures ease of use as a sewing thread.

Any suitable thread may be used. For example, a stainless steel thread coated in Kevlar may typically have a thickness of from 0.1 to 1 mm, such as from 0.2 to 0.7 mm for example from 0.3 to 0.5 mm such as about 0.4 mm. A suitable thread may have a linear mass density (given as d x 1, where d is the value in dtex) of from 50 to 2000, more typically from 100 to 500 such as from 150 to 300 such as around 200×1 dtex. A suitable thread may have strength of from 2 to 8 cN, such as from 3 to 6 cN for example around 3.5 to 5 cN such as about 4 to 4.5 cN e.g. about 4.25 cN. A typical thread may have an elongation of from 5 to 15% such as from 8 to 12% e.g. 9 to 10%.

Threads of quartz, ceramic or glass fibre have high operating temperature limits. Care is necessary with sewing using such fibres often requiring a slow speed to avoid breakage of the thread. High temperature polymers with high tensile strength including polyimides and aramids such as Kevlar are used where temperature resistance is required. The temperature range for operation of such polymer threads may be improved by coating with a coating comprising vermiculite in the same way as the woven material. A preferred thread identified for manufacture of the fire-resistant container is a thread formed from a suitable core material such as a polymer with high tensile strength and high temperature performance, such as Kevlar, where the core is coated or impregnated with a vermiculite coating. Threads with alternative cores coated with a coating comprising vermiculite may be employed including cores comprising metal threads, quartz, ceramic or glass fibre.

For improved fire-resistant properties a fire-resistant container, such as a fire-resistant FIBC, may be made using a layered or sandwich material. The layered or sandwich material comprises an insulating material encased in a wholly, partially or uncoated material. As described below, the insulating material is encased in a partially or wholly coated material, wherein the coating imparts fire-resistance to the material. However, in some aspects of the invention the material surrounding the insulating material is an uncoated material, that is a material which is not coated with a fire-resistant coating. Such materials may have advantages when the insulating layer in the sandwich material is sufficiently fire-resistant as to provide sufficient fire-resistance to the container.

Typically, the insulating material is encased in a partially or wholly coated material, wherein the coating imparts fire-resistance to the material. For example, the coating typically comprises expanded vermiculite. Typically, the insulating materials is surrounded by a material which is wholly or partially coated with a fire-resistant coating as described herein. Thus, the sandwich material comprises one or more layers of a fire-resistant material as described herein. For example, a suitable layered material may comprise two or more layers of a fire-resistant material encasing one or more layers of an insulating material. The two or more layers of a fire-resistant material typically comprise materials comprising vermiculite such as thermally and/or chemically expanded vermiculite, most preferably chemically expanded vermiculite as described herein. The two or more layers of a fire-resistant material may each have a surface density of from 100 to 1000 g/m², such as from 200 to 800 g/m², more typically from 300 to 600 g/m² as described herein.

For example, two layers of fire-resistant material may encapsulate a single layer of an insulating material. Alternatively multiple layers of insulating material may be encapsulated in two or more layers of fire-resistant material. The construction preferably allows for the material of the container to be flexible for ease of transportation and to accommodate load.

The layered sandwich material typically comprises an insulating material. Any suitable material may be used, such as a felt, a ceramic wool, a material coated or impregnated with expanded vermiculite, fibreglass, E-glass, mineral wool and the like. Preferably, the insulating material is a high-silica needle mat. Any suitable thickness of high silica needle mat may be used, for example the thickness of the mat may be from 4 to 30 mm, more typically from 5 to 25 mm, still more typically from 6 to 20 mm, such as from 8 to 15 mm e.g. from 10 to 12 mm such as about 10 mm. The properties of the high silica needle mat can be chosen to impart the desired fire resistance to the FIBC. The surface density of the mat be typically be from 500 to 5000 g/m² such as from 600 to 4500 g/m², e.g. from 900 to 2000 g/m² such as from about 1200 to about 1800 g/m² e.g. from about 1300 to about 1600 g/m².

Although for high temperature application the use of a woven fabric coated with a fire-resistant material is preferred in such a sandwich arrangement for certain applications the use of outer sandwich layers of a woven fabric which has not been coated with a fire-resistant material may provide an acceptable level of fire protection. The present invention therefore further provides for a container constructed from a sandwich material comprising two outer layers of a flexible woven material and an insulating layer where the outer layers are formed of materials with a high level of fire resistance such as fibreglass, glassfibre, E-glass, silica glass or fibres thereof and ceramic glass or fibres thereof wherein one or both of the outer layers are optionally partially or fully coated with a fire-resistant coating.

A fire-resistant material which may optionally comprise a layered sandwich structure and/or an insulating layer may optionally be coated with a coating designed to impart desired characteristics. For example, suitable coatings may impart any or all of the following properties to the material: improved stiffness, improved waterproofing or liquid impermeability, improved strength, improved flexibility and/or improved sift-proof capacity. Any suitable coating may be used, for example rubber, polyvinyl chloride (PVC), polyurethane (PU), silicone elastomer, fluoropolymers, and wax. Most preferably, the coating is fire-resistant. Preferred coatings comprise polyurethane, such as high performance fire-resistant polyurethane. Optionally, the coating may have one or more additives such as a colorants, strengtheners, and the like, such as metal-based pigments e.g. aluminium based pigments. The coating may be applied to either or both faces of the material from which the container is constructed.

For example, a fire-resistant container such as a fire-resistant FIBC may typically be constructed from a layered sandwich material comprising two layers of a woven material coated with expanded vermiculite, as described herein, encapsulating an insulating material comprising a high silica needle mat and coated on the external faces with a polyurethane coating. Typically, the woven material has a surface density of from 200 to 800 g/m² and is treated, coated or impregnated with expanded vermiculite and the insulating material has a thickness of from 8 to 15 mm.

Preferably the fire-resistant material combines the properties of excellent thermal insulation, fire-resistant properties, flexibility and strength and a container can be readily folded without compromising fire-resistant properties in future use.

Thus, for example, a fire-resistant container is provided wherein:
the size of the container is from 0.15m x 0.15 m×0.15 m to 1.2 m×1.2 m×1.2 m (i.e. the container has a volume of from 0.003 m³ to 1.73 m³);
the container comprises a sandwich material wherein
   the external and internal face materials comprise expanded vermiculite impregnated woven fabric having a density of from 400 to 1500 g/m² and temperature resistance of up to 1500° C., and typically having a tensile strength of about 3000 to 4000 N/cm (warp), about 2000 to 3000 N/cm (weft), and a thickness of from about 0.5 to 1 mm
   the internal insulation layer comprises silica glass needle matting having a thickness of from 4 to 30 mm and a temperature resistance of up to 1500° C., and typically having a thickness of from about 5 to 20 mm
the container optionally comprises loops and/or handles comprising stainless steel reinforced silica glass vermiculite coated fabric having a density of from 400 to 1500 g/m² and temperature resistance of up to 1500° C., and typically having a tensile strength of about 500 to 1000 N/cm (warp), about 500 to 1000 N/cm (weft), and a thickness of from about 0.5 to 1 mm
the container optionally comprises a skirt comprising glass fibre vermiculite coated fabric having a density of from 100 to 500 g/m² and temperature resistance of up to 1500° C., and typically having a tensile strength of about 3000 to 4000 N/50 mm (warp), about 1500 to 2000 N/50 mm (weft), and a thickness of from about 0.2 to 0.7 mm, the container is assembled by stitching together panels using a cored thread with a fire-resistant coating, typically a Kevlar coated stainless steel thread with a working temperature up to 1500° C., and typically having a strength of 3.5 to 5 nN and elongation of 5-20%.

A preferred embodiment of the fire-resistant container is a fire-resistant FIBC as shown in FIG. 2, which comprises an FIBC of a fire-resistant material comprising a sandwich of silica-glass fabric coated with a fire-resistant coating comprising chemically expanded vermiculite and a central layer of a high-silica needle mat, the sandwich having an external coating on both faces with a high temperature polyurethane coating, a skirt 6 of a more flexible fire-resistant material comprising a single layer of a silica-glass fabric coated with a fire-resistant coating comprising chemically expanded vermiculite and an outer coating of polyurethane tied by a Kevlar cord and overlayed by a pair of closing flaps 3 of the same sandwich material as the FIBC bottom and sides and closed with a Velcro fastening 11 to 13. The combination of layers in the sandwich material produces excellent thermal insulation and fire-resistant properties while remaining light and foldable without crushing of the insulating core while the polyurethane layer provides protection against moisture and condensation and renders the material sift proof. The use of a more flexible inner skirt assists in meeting the UN Hazardous Goods Packaging Group II standard tests for partially filled bags where the tests require the container to meet specified requirements when there is an unfilled ullage or headroom. The preferred stitching is a stainless steel thread with a Kevlar coating. For additional strength the FIBC may be provided with a stainless steel frame and lifting handles 4 may be provided in the form of steel reinforced high temperature silica glass fabric. Such an embodiment is capable of providing an FIBC meeting the requirements of UN Hazardous Goods Packaging Group II standards and to provide a maximum temperature (continuous) rating of 600, 1000 or 1200 degree centigrade or higher.

### EXAMPLE 1

A woven silica glass fabric was coated with an aqueous dispersion of vermiculite of approximately 10 to 17% solids content (Micashield, supplied by Dupre Minerals) by dip-coating. Excess vermiculite suspension was removed by compression of the coated fabric between two rollers, before the coated fabric was dried by heating. The resultant coated fabric was subjected to an intense flame from an industrial gas blowtorch. Even after extensive application of the flame, the fabric did not ignite.

The impregnated silica glass material of nominal width 90 cm and nominal service temperature of up to 1000° C. was formed into an FIBC of cubic construction in the form of a nominal 85 cm×85cm by 100 cm cuboid with filling and discharge spouts and corner lifting loops and tie tapes all made from the impregnated silica glass fabric as depicted in FIG. 1. All cut or raw edges of the impregnated silica glass material were double turned or J seamed. The nominal width 90 cm impregnated silica glass material was prepared by feathering the edge of the 90 cm wide fabric to form the external 85 cm width. All seams were manufactured using chain or lock stitch sewn with a sewing thread comprising Helios Kevlar sewing thread available from Padtex Insulation which comprises a special steel core and a Kevlar cover.

### EXAMPLE 2

Preliminary testing of open top cuboid FIBCs made from the same material as Example 1 withstood heat applied from outside by blowtorch and withstood exposure to fire inside the FIBC. A limiting factor was identified as the joining thread. Different thread types permitted the FIBC to maintain integrity upon the application of high internal temperature from burning material inside the FIBC for different lengths of time. Whereas threads of quartz, ceramic or glass fibre have high operating temperature limits care is necessary with sewing using such fibres often requiring a slow speed to avoid breakage of the thread. High temperature polymers with high tensile strength including polyimides and aramids such as Kevlar are used where temperature resistance is required. A preferred thread identified for manufacture of the fire-resistant FIBC is a thread formed from a suitable core material such as a polymer with high tensile strength and high temperature performance, such as Kevlar, where the core is coated or impregnated with a vermiculite coating in the same manner as the bag material.

### EXAMPLE 3

Three materials for FIBC manufacture were prepared as follows:

### Material 1

A single sheet of silica glass 600 g/m² coated with Micashield DM338S from Dupres Minerals, a suspension of chemically exfoliated vermiculite.

DM338S is an aqueous dispersion of chemically exfoliated vermiculite having the following properties:
D90: 160-200 μm;
solids content: 16-18%
viscosity: 3000-7000 cps

DM338S comprises vermiculite having the following chemical composition:
SiO₂: 39.4%; K₂O: 4.5%; CO₂: 1.4%; MgO: 25.2%; Fe₂O₃: 4.0%; TiO₂; 0.8%; Al₂O₃: 8.8%; CaO: 1.8%; F: 0.5%

### Material 2

A sandwich comprising two sheets of silica glass 600 g/m² coated with Micashield DM338S and a central layer of 6mm thickness high silica needle mat.

### Material 3

A sandwich comprising two sheets of silica glass 600 g/m² coated with Micashield DM338S and a central layer of 12 mm thickness high silica needle mat.

The three materials were tested for resistance of heat flow across the material. Two thermocouples were placed on opposite faces of the material. A propane burner was adjusted to give a temperature of 1000° C. at a distance of 8 cm from the burner and placed 8 cm from one face of the material. The temperature was measured at the face facing the propane burner, the hot face, and the opposite face of the material, the cold face, over a 20 minute period. The results of the test taken between minutes 10 and 15 are summarised in Tables A to C.

TABLE A
Material 1, one single layer of vermiculite coated silica-glass fabric.

| Thermocouple | Average ° C. | Minimum ° C. | Maximum ° C. |
|---|---|---|---|
| Hot Face | 1006.6 | 1002.1 | 1013.8 |
| Cold Face | 452.1 | 446.5 | 456.0 |

TABLE B
6 mm of insulation between two layers of vermiculite
coated silica-glass fabric.

| Thermocouple | Average ° C. | Minimum ° C. | Maximum ° C. |
|---|---|---|---|
| Hot Face | 999.4 | 996.8 | 1003.2 |
| Cold Face | 224.9 | 222.5 | 226.6 |

TABLE C
12 mm of insulation between two layers of vermiculite
coated silica-glass fabric

| Thermocouple | Average ° C. | Minimum ° C. | Maximum ° C. |
|---|---|---|---|
| Hot Face | 1010.1 | 1008.5 | 1012.8 |
| Cold Face | 135.9 | 134.4 | 137.6 |

### EXAMPLE 4

Fire-resistant materials for use in production of fire-resistant containers as described herein were produced and tested as follows. A test rig exposed the fabric to a weight of 10 kg across an exposed fabric area, corresponding to approximately 1000 kg/m² load. A propane burner was adjusted to produce a flame of 1000° C. and the surface of the material to be tested was exposed to the flame for 15-20 minutes. Results are as shown in Tables D-G and in FIGS. 4 to 8.

TABLE D
Material 1, one single layer of vermiculite coated silica-glass fabric.

| Thermocouple | Average ° C. | Minimum ° C. | Maximum ° C. |
|---|---|---|---|
| Hot Face | 995.3 | 990.5 | 1000 |
| Cold Face | 669.6 | 647.3 | 688.4 |
| Cold Face (1 mm spacing) | 646.0 | 621.0 | 666.8 |

TABLE E
Material 2, one single layer of vermiculite coated silica-glass fabric backed
with 6 mm non-combustible high-silica glass needle matting.

| Thermocouple | Average ° C. | Minimum ° C. | Maximum ° C. |
|---|---|---|---|
| Hot Face | 1013.3 | 1011.7 | 1014.9 |
| Cold Face | 382.3 | 357.5 | 405.6 |
| Cold Face (1 mm spacing) | 330.4 | 303.2 | 355.6 |

TABLE F
Material 3, one single layer of vermiculite coated silica-glass fabric backed
with 10 mm non-combustible high-silica glass needle matting.

| Thermocouple | Average ° C. | Minimum ° C. | Maximum ° C. |
|---|---|---|---|
| Hot Face | 1026.2 | 1017.0 | 1030.9 |
| Cold Face | 296.8 | 271.2 | 320.1 |
| Cold Face (1 mm spacing) | 273.6 | 242.9 | 302.2 |

TABLE G
Material 3, one single layer of vermiculite coated silica-glass fabric backed
with 12 mm non-combustible high-silica glass needle matting.

| Thermocouple | Average ° C. | Minimum ° C. | Maximum ° C. |
|---|---|---|---|
| Hot Face | 1002.7 | 992.6 | 1010.6 |
| Cold Face | 286.7 | 264.2 | 308.2 |
| Cold Face (1 mm spacing) | 285.6 | 262.1 | 307.2 |

### EXAMPLE 5

A fire-resistant container in the form of a fire-resistant FIBC was produced using a sandwich material as described in the preceding Example. The container consisted of two outer layers of high temperature expanded-Vermiculite coated Silica glass fabric. One side of each outer layer was coated with hydrophobic stabilising finish acting as a sacrificial waterproofing layer. Between each of outer layer was a 10 mm layer of insulation material consisting of a non-combustible silica needle matting with a temperature resistance of 1000 C. A grid was placed over a bath of fuel. The container was filled with a flammable material (typically soft-wood or cardboard) arranged in a lattice/grid manner to maximise airflow within the container. After the container was closed with Velcro, the bath of fuel was lit. Typical burn temperatures were in the region of 1000° C. and the fuel lasted for approximately 2 minutes. Once the fuel had been consumed, the fire extinguished. The container appeared unmarked apart from a light coating of soot due to deposition from the fuel. The container was undamaged. The flammable material inside the container showed no sign of damage caused by heat or flame and was not burned or otherwise marked. The inside face of the container was undamaged.

1. A flexible fire-resistant container constructed from a material which comprises expanded vermiculite.

2. A container according to claim 1 wherein the material is a layered material comprising one or more insulating layers and one or more woven materials.

3. A container according to claim 2 wherein the one or more insulating layers are encapsulated in layers of the woven material.

4. A container according to claim 2 wherein the insulating layer comprises a high-silica needle mat.

5. A container according to claim 4 wherein the high silica needle mat has a thickness of from 4 to 30 mm.

6. A container according to claim 2 wherein the woven material is made from fibreglass or fibres thereof, silica glass or fibres thereof, or ceramic glass or fibres thereof.

7. A container according to claim 1 wherein the expanded vermiculite comprises between 90 and 100% chemically exfoliated vermiculite and between 10% and 0% thermally exfoliated vermiculite.

8. A container according to claim 1 wherein the material is further coated with an additional coating which optionally comprises polyurethane.

9. A container according to claim 1 wherein the container comprises (i) a skirt comprising point of access to the container and (ii) a further covering.

10. A container according to claim 1 wherein the woven material of the base, sides and cover of the container have a surface density of from 100 to 1500 g/m².

11. A container according to claim 10 wherein the woven material of the base, sides and cover of the container have a surface density of from 400 to 1500 g/m² and further comprising a skirt comprising an access spout wherein the skirt comprises a woven material with a surface density from 100 to 500 g/m².

12. A container according to claim 1 wherein the container is stitched together with thread wherein the thread comprises a core coated with a fire-resistant coating.

13. A container according to claim 12 wherein the core comprises steel and the coating comprises Kevlar.

14. A container according to claim 1 having a volume of from about 0.0005 m³ to about 0.5 m³.

15. A container according to claim 1 which is an FIBC.

16. A method for producing a fire-resistant container according to-claim 1 comprising either (i) coating a woven material with a fire-resistant coating composition and assembling the coated material into a container; or (ii) wholly or partially forming a container from a woven material and coating the wholly or partially formed container thus produced with a fire-resistant coating composition.
